(19) United States
(12) Patent Application Publication
(10) Pub. No.: US 2011/0153147 A1
(43) Pub. Date: Jun. 23, 2011

(54) PARKING BRAKE CONTROL DEVICE

(75) Inventors: Takashi Watanabe, Aichi-pref (JP); Junichi Kubokawa, Aichi-pref (JP); Kazuhiko Yasui, Aichi-pref (JP)

(73) Assignee: ADVICS CO., LTD, kariya-city (JP)

(21) Appl. No.: 13/060,853

(22) PCT Filed: Aug. 27, 2009
(86) PCT No.: PCT/JP2009/064909

§ 371 Date: Feb. 25, 2011

(30) Foreign Application Priority Data
Sep. 1, 2008 (JP) 2008-223367

(51) Int. Cl. G06F 19/00; F16D 55/226

(52) U.S. Cl. 701/29; 188/72.4

(57) ABSTRACT

[Problem] A parking brake control device can ensure required braking force and reliably allow release even if an automatic pressurization function that increases a W/C pressure is malfunctioning, regardless of operation of a brake pedal.

[Solution] If an ESC is malfunctioning when a locking control or a releasing control of a parking brake is being performed, a depression request for a brake pedal is output to a driver. As a result, when the ESC is malfunctioning, namely, even if an automatic pressurization function of a service brake is malfunctioning, a W/C pressure can be increased by the driver depressing the brake pedal. Thus, it is possible to ensure required braking force at times when the locking control is being performed, and also possible to reliably release when the releasing control is being performed.

### TECHNICAL FIELD

The present invention relates to a parking brake control device that performs a locking control of an electric parking brake (hereinafter referred to as “EPB”).

### BACKGROUND ART

In known art, a parking brake is used to restrict the movement of a vehicle when it is parked. Examples of such a parking brake include a manual parking brake in which an operation lever is used to pull a brake cable so as to transmit an operation force to a brake mechanism, or an electric parking brake in which rotational force of a motor is used to pull the cable to transmit the motor rotational force to the brake mechanism, etc.

In an electric parking brake or EPB, to lock the EPB, the motor is turned to a locking side (turned forward) and motor rotational force is transmitted to the brake mechanism (actuator). At the same time, while braking force is being generated, motor drive is stopped. To release the EPB, the motor is turned to a releasing side (turned backward) to release the braking force.

An EPB that perform this type of locking-releasing control is disclosed in Published Japanese Translation of PCT application JP-T-2007-519568, which uses an automatic pressurization function of a service brake in order to reduce output of the motor when braking to park. More specifically, on a level road where load is comparatively small and it is not necessary to generate a particularly substantial braking force, only a motor for parking braking use is activated. However, on a sloping road where load is comparatively large and a substantial braking force does need to be generated, the service brake is used to compensate for the amount of force that the parking brake cannot generate so as to ensure that braking force is sufficient to inhibit the vehicle from slipping downhill.

### SUMMARY OF INVENTION

### Technical Problem

However, in the case of providing compensating braking force using the service brake as in the known art, if the automatic pressurization function of the service brake suffers a malfunction, it is necessary to generate the required braking force using only operation of the break mechanism of the parking brake. As a result, there are times when problems occur such as it not being possible to ensure the required braking force on a sloping road, or not being able to release the parking brake due to the motor not operating and being un-releasable because of not being able to apply a pressure equivalent to a wheel cylinder (hereinafter referred to as “W/C”) pressure generated when locking took place, even if the parking brake is intended to be released following parking using the parking brake.

The present invention has been devised in light of the foregoing circumstances, and it is an object thereof to provide a parking brake control device that can ensure required braking force and reliably allow release even if an automatic pressurization function that increases a W/C pressure is malfunctioning, regardless of operation of a brake pedal.

### Solution to Problem

In order to achieve the above object, the invention according to claim 1 is characterized by including a pressurization malfunction determination means (210, 305) that determines whether an automatic pressurization function of a second brake means (1) is malfunctioning. A depression request means (220, 315) makes a depression request to a driver to request depression of a brake pedal (3) if the pressurization malfunction determination means (210, 305) determines that the automatic pressurization function is malfunctioning.

In this way, if the automatic pressurization function of the second brake means (1) is malfunctioning when a locking control or a releasing control of a parking brake is being performed, the depression request for the brake pedal (3) is output to the driver. As a result, even if the automatic pressurization function is malfunctioning, the W/C pressure can be increased by the driver depressing the brake pedal. Thus, it is possible to ensure required braking force at times when the locking control is being performed, and also possible to reliably release when the releasing control is being performed.

It is possible for the structure to include, as disclosed in claim 2, for example, a target value setting means (200, 300) that sets a target value (TPWC, PLMC+C) of a wheel cylinder pressure when the locking control or the releasing control is being performed; and a pressure obtaining means (205, 300) that obtains the generated wheel cylinder pressure (PWC); and a pressure determination means (205, 300) that, when the first brake means (2) generates braking force, determines whether the wheel cylinder pressure (PWC) generated by the second brake means has exceeded the target value (TPWC, PLMC+C). If the pressure determination means (205, 300) determines that the wheel cylinder pressure (PWC) has not exceeded the target value (TPWC) and the pressurization malfunction determination means (210, 305) determines that the automatic pressurization function is malfunctioning, the depression request means (220, 315) makes a depression request to the driver requesting depression of the brake pedal (3).

The invention according to claim 3 is characterized in that after the depression request means (220, 315) has made the depression request, if the pressure determination means (205, 300) determines that the wheel cylinder pressure (PWC) has exceeded the target value (TPWC, PLMC+C), the maintenance means (230, 315) maintains the wheel cylinder pressure (PWC) while the cancellation means (270c, 360c) cancels the depression request for the brake pedal (3) if a maintenance determination means (270b, 360b) determines that the maintenance function is not malfunctioning

In this way, even if the second brake means (1) is malfunctioning, in cases where it is still possible to maintain the W/C pressure depending on a section that is malfunctioning, the driver can be induced to depress the brake pedal (3) once to pressurize the W/C. Following this, the W/C pressure can be maintained so that no problems occur even if the driver does not continue depression anymore. As a result, it is possible to reduce the extent to which the driver is put to the inconvenience of depressing the brake pedal (3).

The invention disclosed in claims 4, 6, 8 is characterized in that the depression request means (220, 315) varies a warning level of the depression request given to the driver in accordance with a required depression amount of the brake pedal (3).

In this way, if a depression request is made to the driver, it is possible to change the warning level given to the driver when depression is requested in accordance with the required depression amount. As a result, it is possible to induce the driver to depress the brake pedal (3) with a more appropriate degree of force.

As like the invention disclosed in claims 5, 7, 9, for example, it is possible to adopt a structure in which the depression request means (220, 315) includes: a depression amount determination means (220a, 315a) that determines whether a difference (TPWC−PWC, PLMC+C−PWC) between the target value (TPWC, PLMC+C) and the generated wheel cylinder pressure (PWC) exceeds a threshold value (KPW); and a means (220b, 220c, 315b, 315c) that, if the depression amount determination means (220a, 315a) determines that the difference (TPWC−PWC, PLMC+C−PWC) exceeds the threshold value (KPW), makes the warning level of the depression request a higher level as compared to if the difference does not exceed the threshold value (KPW).

The invention disclosed in claim 10 is characterized in that the depression request means (220, 315) includes: a depression determination means (220d, 315d) that determines whether the brake pedal (3) is being depressed; and an urging means (220e, 220f, 315e, 315f) that, if the depression determination means (220d, 315d) determines that the brake pedal (3) is not being depressed, urges depression of the brake pedal (3) to be performed, and if it is determined that the brake pedal (3) is being depressed, urges that the brake pedal (3) is depressed further.

In other words, the warning method is modified in accordance with the state of brake depression by the driver, and if the brake pedal (3) has not yet been depressed, the driver is urged to depress it, and if the brake pedal (3) is already being depressed, the driver is urged to depress it more firmly.

Note that, the reference numbers in brackets for each of the above described means are intended to show the relationship with the specific means described in the following embodiments.

### BRIEF DESCRIPTION OF DRAWINGS

FIG. 1 is a schematic figure that shows an overall outline of a vehicle brake system to which a parking brake control device according to a first embodiment of the present invention is applied.

FIG. 2 is a schematic section view of a rear wheel brake mechanism that is provided in the brake system that is shown in FIG. 1.

FIG. 3 is a flowchart that shows details of parking brake control processing.

FIG. 4 is a flowchart that shows details of locking control processing.

FIG. 5 is a map that shows the relationship between a vehicle front-rear G that is taken as a road surface gradient corresponding amount and a target W/C pressure TPWC.

FIG. 6 is a flowchart that shows details of releasing control processing.

FIG. 7 is a map that shows a characteristic MAP (PLMC) of a release drive time KTR with respect to the W/C pressure PLMC when locking control is terminated.

FIG. 8 is a flowchart that shows details of locked/released display processing.

FIG. 9 is a timing chart for when the parking brake control processing is performed.

FIG. 10 is a timing chart for when the parking brake control processing is performed.

FIG. 11 is a timing chart for when the parking brake control processing is performed.

FIG. 12 is a flowchart that shows details of locking control processing according to a second embodiment of the present invention.

FIG. 13 is a flowchart that shows details of releasing control processing according to the second embodiment of the present invention.

FIG. 14 is a flowchart that shows details of locking control processing according to a third embodiment of the present invention.

FIG. 15 is a flowchart that shows details of releasing control processing according to the third embodiment of the present invention.

FIG. 16 is a flowchart that shows details of locking control processing according to a fourth embodiment of the present invention.

FIG. 17 is a flowchart that shows details of releasing control processing according to the fourth embodiment of the present invention.

### DESCRIPTION OF EMBODIMENTS

Hereinafter, embodiments of the present invention will be explained based on the drawings. Note that portions that are the same or equivalent to each other in each of the embodiments that are hereinafter described are assigned the same reference numerals in the drawings.

### First Embodiment

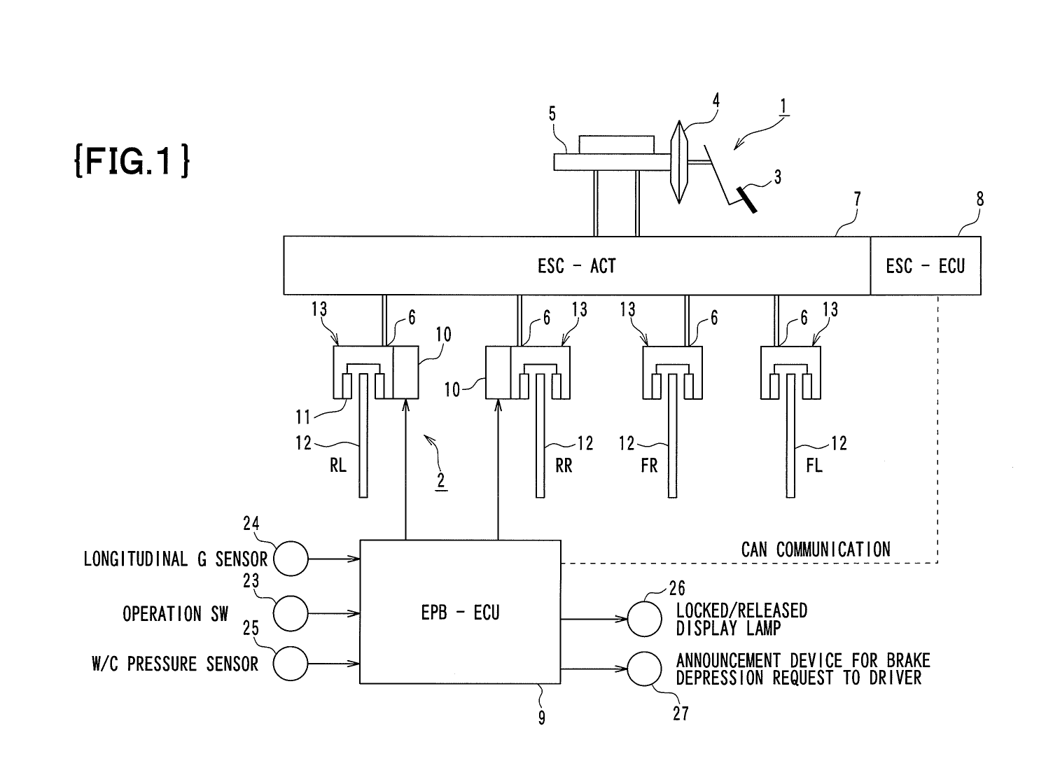

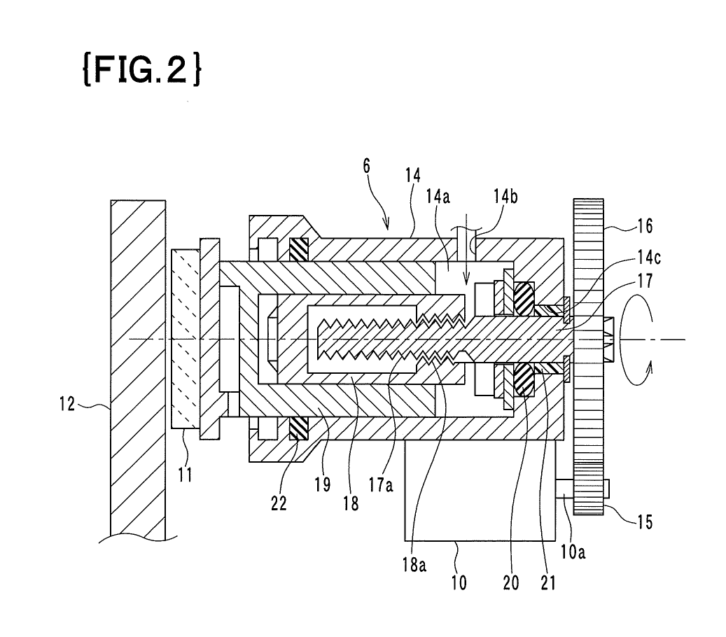

A first embodiment of the present invention will be explained. The present embodiment uses as an example a vehicle brake system in which a disc brake EPB is applied to a rear wheel. FIG. 1 is a schematic figure that shows an overall outline of the vehicle brake system to which a parking brake control device according to the present embodiment is applied. FIG. 2 is a schematic section view of a rear wheel brake mechanism that is provided in the brake system. Hereinafter, the present embodiment will be explained with reference to the drawings.

As shown in FIG. 1, the brake system is provided with a service brake 1, which is equivalent to a second brake means that generates a braking force based on a pedal force of a driver, and with an EPB 2, which is equivalent to a first brake means for restricting the movement of the vehicle when it is parked.

For the service brake 1, the pedal force, which corresponds to the extent to which the driver depresses a brake pedal 3, is multiplied by a servo unit 4. A brake fluid pressure that corresponds to the multiplied pedal force is then generated within a master cylinder (hereinafter called the M/C) 5, and the brake fluid pressure is transmitted to a wheel cylinder (hereinafter called the W/C) 6 that is provided in a brake mechanism for each of the wheels, thus generating the braking force. An actuator 7 for controlling the brake fluid pressure is provided between the M/C 5 and the W/Cs 6 and serves as a mechanism that regulates the braking force that is generated by the service brake 1 and performs various types of control (for example, anti-skid control and the like) in order to improve the stability of the vehicle.

The various types of control using the actuator 7 are performed by an Electronic Stability Control (ESC) ECU 8. For example, by outputting a control current in order to control various types of control valves and pump-operating motors that are provided in the actuator 7 and are not shown in the drawings, the ESC ECU 8 controls a hydraulic pressure circuit that is provided in the actuator 7 and controls a W/C pressure that is transmitted to the W/Cs 6. This inhibits the wheels from slipping and improves the stability of the vehicle. For example, for each of the individual wheels, the actuator 7 is provided with a pressure-boosting control valve that controls the brake fluid pressure that is applied to the W/C 6. The brake fluid pressure is generated within the M/C 5 or generated by the operation of a pump. The actuator 7 is also provided with a pressure-reducing control valve that reduces the W/C pressure by supplying the brake fluid within each of the W/Cs 6 to a reservoir. The actuator 7 is also provided with a differential pressure control valve that is positioned to the M/C 5 side of an auxiliary conduit and that receives discharge pressure of a pump in a main conduit that connects the M/C 5 and the W/Cs 6. As a result, the actuator 7 has a configuration that is able to boost, maintain, and reduce the W/C pressure. The configuration of the actuator 7 is known and so a detailed explanation will be omitted.

Furthermore, the ESC ECU 8 also checks that pressure is not being increased due to automatic pressure increase of the W/C pressure using the actuator 7 due to a malfunction of the various types of control valve or a pump drive motor provided in the actuator 7, namely, by an automatic pressurization function of the service brake 1. For example, automatic increase of the W/C pressure by driving the actuator 7 does not occur if there is a malfunction of the differential pressure control valve provided in the main conduit connecting the M/C 5 and the W/Cs 6. As a result, initial checks etc. are performed in advance to detect whether or not the various types of control valve and the motor are operating normally, thereby making it possible to check whether automatic pressurization of the W/C pressure is not being performed by drive of the actuator 7 depending on the location of a malfunction.

In contrast, the EPB 2 generates a braking force by using a motor 10 to control the brake mechanisms. The EPB 2 is configured such that it includes an EPB control unit (hereinafter called the EPB ECU) 9 that controls the operation of the motor 10.

The brake mechanisms are mechanical structures that generate the braking force in the brake system according to the present embodiment. The front wheel brake mechanisms are structures that generate the braking force in accordance with the operation of the service brake 1, while the rear wheel brake mechanisms are dual-operation structures that generate the braking force in accordance with both the operation of the service brake 1 and the operation of the EPB 2. In contrast to the rear wheel brake mechanisms, the front wheel brake mechanisms are brake mechanisms that have been in general use for some time and that lack a mechanism that generates the braking force based on the operation of the EPB 2, so an explanation will be omitted. In the explanation that follows, the rear wheel brake mechanisms will be explained.

In the rear wheel brake mechanism, both when it is operated by the service brake 1 and when it is operated by the EPB 2, pressure is applied to brake pads 11, one of which is shown in FIG. 2, such that the brake pads 11 pinch a brake disc 12. A friction force is generated between the brake pads 11 and the brake disc 12, thereby generating the braking force.

Basically, the brake mechanism turns the motor 10, which is directly attached to a body 14 of the W/C 6, as shown in FIG. 2, in order to apply the pressure to the brake pads 11 on the inside of a caliper 13 that is shown in FIG. 1. This in turn rotates a spur gear 15 that is provided on a drive shaft 10a of the motor 10, and the rotational force of the motor 10 is transmitted to a spur gear 16 that meshes with the spur gear 15. This moves the brake pads 11, such that the braking force is generated by the EPB 2.

In addition to the W/C 6 and the brake pads 11, a portion of an edge face of the brake disc 12 is accommodated within the caliper 13, such that it is pinched by the brake pads 11. The W/C 6 generates the W/C pressure by introducing brake fluid via a passage 14b into a hollow portion 14a of the body 14 that is cylindrical. A rotating shaft 17, an impelling shaft 18, a piston 19, and the like are provided within the hollow portion 14a.

One end of the rotating shaft 17 is passed through an insertion hole 14c that is formed in the body 14 and is coupled to the spur gear 16, such that when the spur gear 16 is rotated, the rotating shaft 17 is rotated in conjunction with the rotation of the spur gear 16. At the opposite end of the rotating shaft 17 from the end that is coupled to the spur gear 16, a male threaded groove 17a is formed on the outer circumferential face of the rotating shaft 17. Furthermore, the other end of the rotating shaft 17 is supported by being inserted into the insertion hole 14c. Specifically, an O ring 20, along with a bearing 21, is provided in the insertion hole 14c. The O ring 20 prevents the brake fluid from leaking out between the rotating shaft 17 and an inner wall face of the insertion hole 14c, and the bearing 21 supports the other end of the rotating shaft 17.

The impelling shaft 18 is configured as a hollow cylindrical member, and a female threaded groove 18a that is threaded together with the male threaded groove 17a of the rotating shaft 17 is formed on an inner wall of the impelling shaft 18. The impelling shaft 18 is formed into either a circular columnar shape or a polygonal columnar shape and is provided with a key, for example, to prevent it from rotating, such that even if the rotating shaft 17 rotates, the impelling shaft 18 is not rotated around the center of rotation of the rotating shaft 17. Therefore, when the rotating shaft 17 is rotated, the engaging of the male threaded groove 17a and the female threaded groove 18a causes the rotational force of the rotating shaft 17 to be converted into a force that moves the impelling shaft 18 in the axial direction of the rotating shaft 17. When the operation of the motor 10 is stopped, the impelling shaft 18 is stopped in the same position by the friction force that is generated by the engaging of the male threaded groove 17a and the female threaded groove 18a. Thus, when a target braking force is achieved, the impelling shaft 18 can be kept in that position by stopping the operation of the motor 10.

The piston 19 is disposed such that it encloses the outer circumference of the impelling shaft 18, so it is formed as a circular cylindrical member or a polygonal cylindrical member that has a bottom, and it is disposed such that its outer circumferential face is in contact with an inner wall face of the hollow portion 14a of the body 14. A seal member 22 is provided on the inner wall face of the body 14, such that leakage of the brake fluid will not occur between the outer circumferential face of the piston 19 and the inner wall face of the body 14, and the piston 19 is structured such that the W/C pressure can be applied to an end face of the piston 19. Furthermore, in a case where the impelling shaft 18 is provided with a key to prevent it from rotating, such that even if the rotating shaft 17 rotates, the impelling shaft 18 is not rotated around the center of rotation of the rotating shaft 17, the piston 19 is provided with a key slot in which the key slides. In a case where the impelling shaft 18 has a polygonal columnar shape, the piston 19 has a corresponding polygonal cylindrical shape.

The brake pad 11 is disposed on the end of the piston 19 and is moved to the left and to the right in FIG. 2 in conjunction with the movement of the piston 19. Specifically, the piston 19 is configured such that it can move to the left in FIG. 2 in conjunction with the movement of the impelling shaft 18, and when the W/C pressure is applied to the end of the piston 19 (the opposite end to the end where the brake pad 11 is disposed), the piston 19 can move to the left in FIG. 2 independently of the impelling shaft 18. Moreover, when the impelling shaft 18 is in its initial position (the state before the motor 10 is rotated), if the brake fluid pressure is not being applied within the hollow portion 14a (the W/C pressure is zero), a return spring that is not shown in the drawings or a negative pressure within the hollow portion 14a moves the piston 19 to the right in FIG. 2, such that the brake pad 11 is separated from the brake disc 12. Further, when the W/C pressure drops to zero when the motor 10 is rotated and the impelling shaft 18 is moved to the right in FIG. 2 from its initial position, the movement of the piston 19 to the right in FIG. 2 is restricted by the moved impelling shaft 18, so the brake pad 11 is kept in that position.

In the brake mechanism with this configuration, when the service brake 1 is operated, the piston 19 is moved to the left in FIG. 2 as a result of the W/C pressure that has thereby been generated. As a result, the brake pads 11 are pressed against the brake disc 12, generating the braking force. Furthermore, when the EPB 2 is operated, the spur gear 15 is rotated by the operation of the motor 10, such that the spur gear 16 and the rotating shaft 17 are also rotated. As a result, the impelling shaft 18 is moved toward the brake disc 12 (toward the left in FIG. 2) due to the engaging of the male threaded groove 17a and the female threaded groove 18a. At the same time, the piston 19 is also moved in the same direction, such that the brake pads 11 are pressed against the brake disc 12, and the braking force is generated. It is therefore possible to achieve a dual-operation brake mechanism in which the braking force is generated in response to both the operation of the service brake 1 and the operation of the EPB. 2.

Furthermore, if the EPB 2 is operated in a state in which the W/C pressure is being generated by the operation of the service brake 1, the piston 19 has already been moved to the left in FIG. 2 by the W/C pressure, so the load on the impelling shaft 18 is reduced. Therefore, the motor 10 is operated in an almost unloaded state until the impelling shaft 18 comes into contact with the piston 19. Then, when the impelling shaft 18 comes into contact with the piston 19, a pressing force is applied that pushes the piston 19 to the left in FIG. 2, such that the braking force is generated by the EPB 2.

The EPB ECU 9 is configured from a known microcomputer that is provided with a CPU, a ROM, a RAM, an I/O, and the like, and it performs parking brake control by controlling the rotation of the motor 10 in accordance with a program that is stored in the ROM or the like. The EPB ECU 9 is equivalent to the parking brake control device of the present invention. The EPB ECU 9 may input a signal or the like that corresponds to an operating state of an operation switch (SW) 23 that is provided on an instrument panel (not shown in the drawings) within the vehicle cabin, or detection signals of a longitudinal acceleration sensor (longitudinal G sensor) 24 that detects a vehicle longitudinal acceleration and a W/C pressure sensor 25. The EPB ECU 9 may then operate the motor 10 in accordance with the operating state of the operation SW 23, or the vehicle front-rear direction acceleration and the W/C pressure.

The EPB ECU 9 also outputs, to a locked/released display lamp 26 that is provided on the instrument panel, a signal that indicates whether the parking brake is locked or released, and outputs a request signal to an announcement device 27 when a brake depression request is output to the driver. Note that, it is possible to use any device for the announcement device 27 so long as the device can transmit a request to the driver that brake depression is wanted. For example, a voice output device that makes a request using speech that announces “Please depress the brake” can be used. Alternatively, speech need not be used and instead it is possible to utilize a display device that makes the driver visually aware that there is a brake depression request.

Specifically, the EPB ECU 9 includes various functional portions including a motor current detection portion that detects, on an upstream side or a downstream side of the motor 10, an electric current (a motor current) that flows in the motor 10, a motor voltage detection portion that detects a motor voltage applied to the motor 10, a motor cut current computation portion that computes a motor cut current (a target current value) when the locking control is terminated, and a portion for performing locking and releasing control, such as a determination as to whether or not the motor current has reached the motor cut current, a control of the motor 10 that is based on the operating state of the operation SW 23, and the like. The EPB ECU 9 performs the locking and releasing control of the EPB 2 by turning the motor 10 in a forward direction, turning the motor 10 in reverse, and stopping the rotation of the motor 10, based on the state of the operation SW 23 and on the motor current.

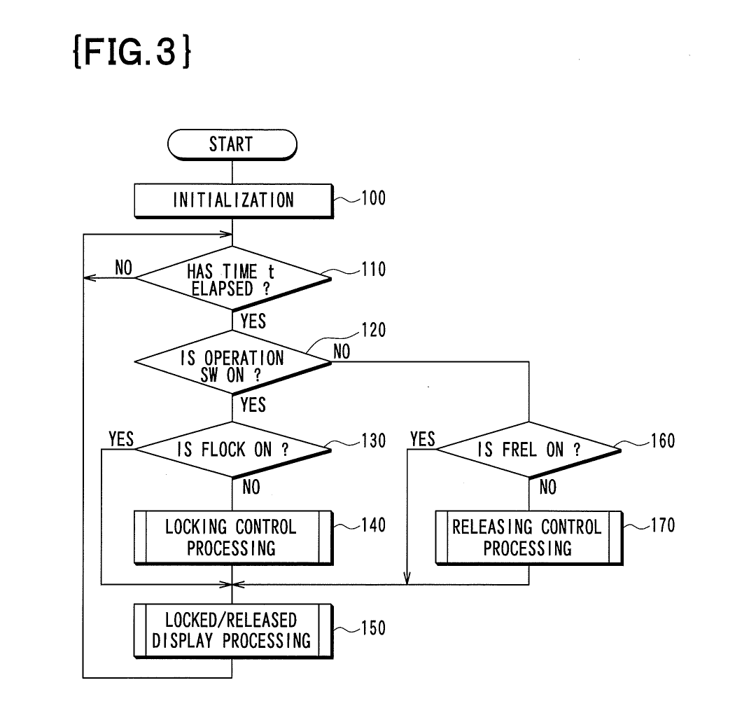

Next, an explanation will be given concerning the parking brake control performed by the EPB ECU 9 through the various types of functional portions that are described above in accordance with a program that is stored in an internal ROM that is not shown in the drawings, using the brake system that is configured as described above. FIG. 3 is a flowchart that shows details of parking brake control processing.

First, ordinary initialization processing such as resetting a time measurement counter, a flag, and the like is performed at Step 100, after which the processing advances to Step 110 and determines whether or not a time t has elapsed. The time t defines a control cycle. In other words, the determination at Step 110 is repeatedly performed until either the time that has elapsed since the initialization processing was completed or the time that has elapsed since the last time that it was determined at Step 110 that the time t had elapsed equals the time t, such that the parking brake control is performed every time that the time t elapses.

Next, at Step 120, a determination is made as to whether or not the operation SW 23 is on. A state in which the operation SW 23 is on means that the driver has operated the EPB 2 to put it into the locked state, and a state in which the operation SW 23 is off means that the driver has put the EPB 2 into the released state. Therefore, if the operation SW 23 is on at Step 120, the processing advances to Step 130, where a determination is made as to whether or not a locked state flag FLOCK has been set to on. The locked state flag FLOCK is a flag that is set to on when the EPB 2 is operated and put into the locked state, so when the locked state flag FLOCK has been set to on, a state exists in which the operation of the EPB 2 has been completed and the desired braking force has been generated. Therefore, the processing advances to locking control processing at Step 140 only if a no determination is made, and if a yes determination is made, the locking control processing has already been completed, so the processing advances to Step 150.

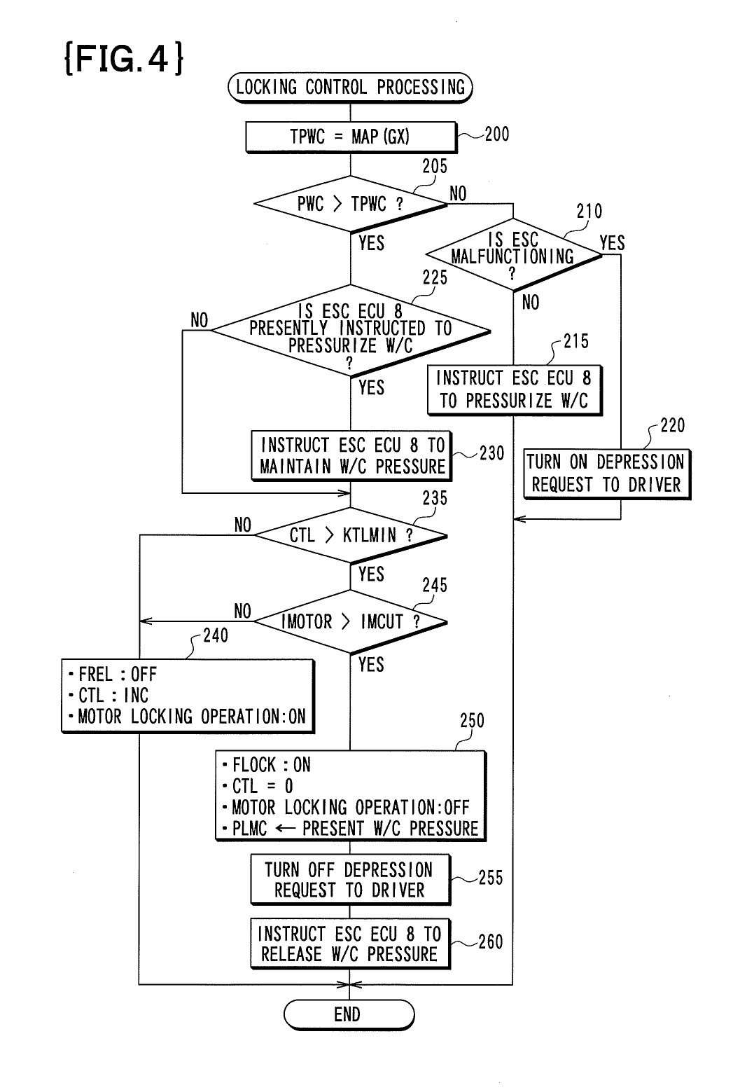

In the locking control processing, processing is performed that operates the EPB 2 by rotating the motor 10, that stops the rotation of the motor 10 in the position where the desired braking force has been generated by the EPB 2, and that maintains that state. A flowchart that shows details of the locking control processing is shown in FIG. 4, and the locking control processing will be explained with reference to FIG. 4.

First, at Step 200, a target W/C pressure TPWC is set. The target W/C pressure TPWC specifies a target value for the W/C pressure generated by the service brake 1. By controlling the W/C pressure to reach this target value, it is possible to inhibit the W/C pressure becoming excessive or the W/C pressure being inadequate when braking to park. The target W/C pressure TPWC is set to be equal or above a W/C pressure that corresponds to a minimum braking force that can maintain a parked state, and is a value that is determined based on the road gradient where the vehicle is being parked etc. In the present embodiment, a map is created in advance of target W/C pressure TPWCs that correspond to road gradients. A road gradient or a road gradient corresponding amount is then derived, and a value is selected that corresponds to the road gradient or the road gradient corresponding amount derived from the map so as to obtain the target W/C pressure TPWC.

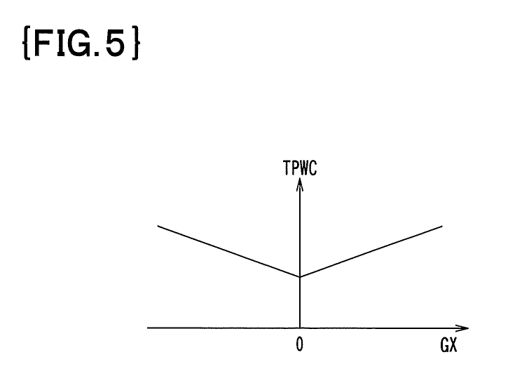

FIG. 5 is a map that illustrates one example of the above, and is a map that shows the relationship between the vehicle longitudinal G that is taken as the road gradient corresponding amount and the target W/C pressure TPWC. As can be seen from the figure, the map is drawn such that the target W/C pressure TPWC increases as the magnitude Gx of the longitudinal G increases, namely, the target W/C pressure TPWC increases proportionally to the magnitude of the road gradient. As a result, in the case of the present embodiment, the magnitude Gx of the longitudinal G is computed based on a detection signal of the longitudinal G sensor 24, and the target W/C pressure TPWC corresponding to the computed longitudinal G is read off the map shown in FIG. 5 to obtain the target W/C pressure TPWC.

If the target W/C pressure TPWC is set in this way, the processing advances to Step 205 where it is determined whether or not a present W/C pressure PWC detected based on a detection signal of the W/C pressure sensor 25 is greater than the target W/C pressure TPWC. If the determination is no, the W/C needs to be pressurized and thus the processing advances to Step 210.

At step 210, it is determined whether or not the ESC is malfunctioning. If the ESC is malfunctioning it means that there is a state in which automatic pressurization is not being performed by the automatic pressurization function of the service brake 1 due to the actuator 7 malfunctioning. The ESC ECU 8 manages matters related to the malfunction of the actuator 7, and thus information concerning whether or not the ESC is malfunctioning at that time can be obtained from the ESC ECU 8 and this information can be used as a basis for making the determination of the processing of Step 210.

Next, if the ESC is not malfunctioning, the processing advances to Step 215 where a W/C pressurization instruction is output to the ESC-ECU 8, and also a flag is set that indicates that there is presently an instruction to pressurize the W/C. Accordingly, the ESC ECU 8 leaves a pressure-boosting control valve, not shown in the figures, in a connected state, and also sets the differential pressure control valve to a differential pressure state. In addition, the ESC ECU 8 operates the motor and makes the pump perform an intake-discharge operation to pressurize the W/C.

On the other hand, if the ESC is malfunctioning, the processing advances to Step 220, and the depression request to the driver is turned on. Then, a signal indicating the depression request to the driver is output to the announcement device 27, and the announcement device 27 uses speech guidance saying “Please depress the brake” etc. to inform the driver. Accordingly, the driver can be induced to depress the brake pedal 3, and a W/C pressure that corresponds to the depression of the brake pedal 3 can be generated.

Thus, even if the actuator 7 is malfunctioning, the driver can be induced to generate the W/C pressure using the service brake 1. In this state, if the EPB 2 is operated, because the piston 19 has already been moved to the left hand side of the figure by the W/C pressure, the load applied to the impelling shaft 18 is reduced. As a result, the motor 10 is operated in an almost unloaded state until the impelling shaft 18 comes into contact with the piston 19. Then, when the impelling shaft 18 comes into contact with the piston 19, a pressing force is applied that pushes the piston 19 to the left in the figure, such that the braking force is generated by the EPB 2.

In this manner, even if the actuator 7 is malfunctioning, the W/C pressure can be generated by the service brake 1 by depression of the brake pedal 3 by the driver, thus making it possible to maintain required braking force. In addition, in the case that no support is provided for the W/C pressure generated by the service brake 1, it is necessary to increase the size of the motor 10 etc. in order to maintain responsiveness etc. However, since support can be obtained by the driver depressing the brake pedal 3, there is no need to increase the size of the motor 10 etc. and thus size reduction of the motor 10 can be promoted.

On the other hand, if there is a yes determination at Step 205, a state has been reached in which it is no longer necessary to pressurize the W/C since the W/C pressure generated due to the depression of the brake pedal 3 by the driver or due to the ESC ECU 8 actuating the actuator 7 is sufficient. As a result, the processing advances to Step 225, and it is determined whether or not the ESC ECU 8 is presently being instructed to pressurize the W/C. This determination is made based on whether or not the flag is set that indicates that there is presently an instruction to pressurize the W/C. If the flag has been set in the above described Step 215, a yes determination is made, and the flag that indicates that there is presently an instruction to pressurize the W/C is reset. Then, the processing advances to Step 230 where a W/C pressure maintenance instruction is output to the ESC ECU 8. After that, the processing advances to Step 235. As a result, the ESC ECU 8 uses a maintenance function to place the pressure-boosting control valve and the pressure-reducing control valve, not shown in the figure, into a non-connected state, whereby the W/C pressure is maintained. Alternatively, a no determination is made if the flag is not set that indicates that there is presently an instruction to pressurize the W/C, and the processing proceeds as is to Step 235.

At Step 235, a determination is made as to whether or not a locking control time counter CTL is greater than a minimum locking control time KTLMIN that has been set in advance. The locking control time counter CTL is a counter that measures the time that has elapsed since the locking control was started, and it starts counting at the same time that the locking control is started. The minimum locking control time KTLMIN is the minimum time that is assumed to be required for the locking control, and it is a value that is determined in advance in accordance with the rotation speed of the motor 10 and the like. When a motor current IMOTOR has reached a target current value IMCUT, a determination is made, as at Step 245 which will be described later, that the braking force that is generated by the EPB 2 has either reached or approached a desired value. However, it is possible that the motor current IMOTOR will exceed the target current value IMCUT, due to a rush current or the like when the supply of the current to the motor 10 is initiated. Therefore, comparing the locking control time counter CTL to the minimum locking control time KTLMIN can mask the time when the control is initiated and makes it possible to prevent an erroneous determination from being made due to the rush current or the like.

Therefore, if a state exists in which the locking control time counter CTL has not exceeded the minimum time, the locking control will still be continued, so the processing advances to Step 240, where a released state flag is set to off, the locking control time counter CTL is incremented, and a motor locking operation is turned on, that is, the motor 10 is rotated in the forward direction. Thus the flat gear 15 is driven in conjunction with the forward rotation of the motor 10, the flat gear 16 and the rotating shaft 17 rotate, and the impelling shaft 18 is moved toward the brake disc 12 due to the engaging of the male threaded groove 17a and the female threaded groove 18a. The piston 19 is also moved in the same direction, such that the brake pad 11 moves toward the brake disc 12.

On the other hand, if a yes determination is made at Step 235, the processing advances to Step 245, where a determination is made as to whether or not the motor current IMOTOR has exceeded the target current value IMCUT in the current control cycle. The motor current IMOTOR fluctuates according to the load that is imposed on the motor 10, but in the present embodiment, the load that is imposed on the motor 10 is equivalent to the pressing force that presses the brake pad 11 against the brake disc 12, so the motor current IMOTOR is a value that corresponds to the generated pressing force. Therefore, if the motor current IMOTOR has exceeded the target current value IMCUT, a state exists in which the desired braking force has been generated by the generated pressing force. In other words, a state exists in which the EPB 2 is pressing a friction face of the brake pad 11 against an inner wall face of the brake disc 12 with a certain force. Accordingly, the processing at Step 240 is repeatedly performed until a yes determination is made in the present step, and then the processing advances to Step 250.

Next, at Step 250, the locked state flag FLOCK is set to on, meaning that the locking has been completed, the locking control time counter CTL is set to zero, and the motor locking operation is turned off (stopped). This causes the rotation of the motor 10 to be stopped and the rotation of the rotating shaft 17 to be stopped, while the friction force that results from the engagement of the male threaded groove 17a and the female threaded groove 18a keeps the impelling shaft 18 in the same position, so the braking force that is generated at that time is maintained. The movement of the parked vehicle is thus restricted. In addition, the W/C pressure PWC generated at that time is memorized as a W/C pressure PLMC when the locking control processing is completed.

Next, the processing advances to Step 255, where the depression request to the driver is turned off Thus, output to the announcement device 27 of the signal that indicates a depress request to the driver is terminated, and the speech guidance “Please depress the brake” or the like from the announcement device 27 is stopped. Then, the processing advances to Step 260, where a W/C pressure release instruction is output to the ESC ECU 8. Accordingly, the W/C pressure generated by the service brake 1 is released, and the parked state is maintained by the parking brake based on the EPB 2. With this, the locking control processing is completed.

In contrast, if a no determination is made at Step 120, the processing advances to Step 160, and a determination is made as to whether or not a released state flag FREL has been set to on. The released state flag FREL is a flag that is set to on when the EPB 2 is operated and put into the released state, that is, the state in which the braking force generated by the EPB 2 has been released, so when the released state flag FREL has been set to on, a state exists in which the operation of the EPB 2 has been completed and the braking force has been released. Therefore, the processing advances to releasing control processing at Step 170 only in the case that a no determination is made at this step, and in a case where a yes determination is made, the releasing control processing has already been completed, so the processing advances to Step 150.

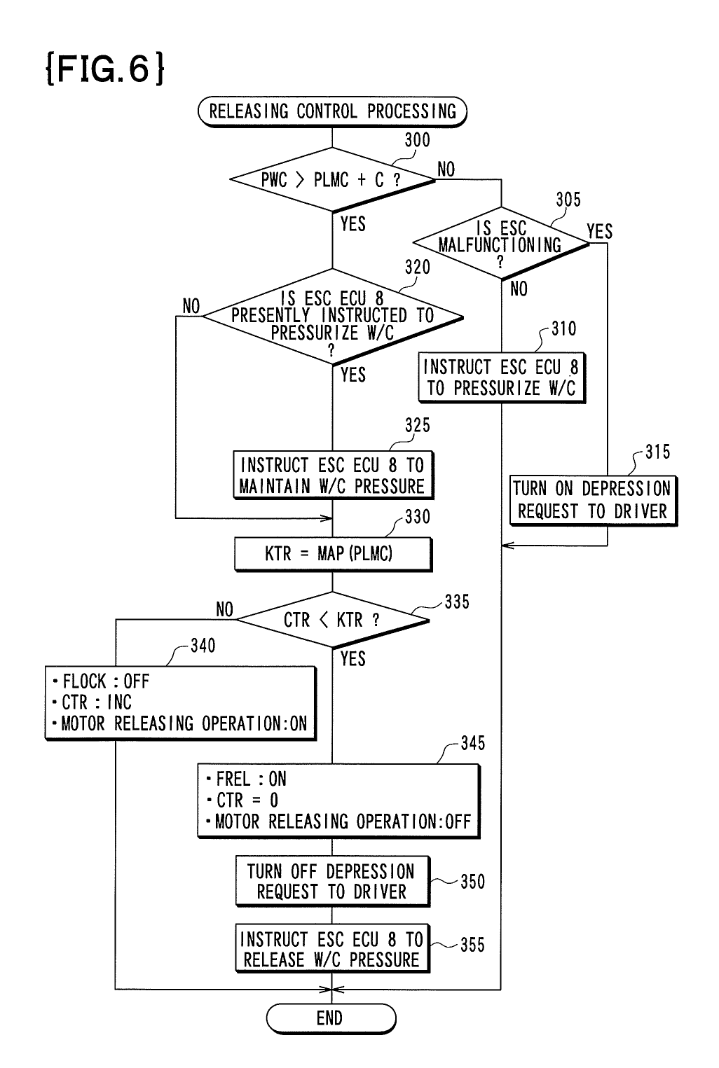

In the releasing control processing, processing is performed that operates the EPB 2 by turning the motor 10, and that releases the braking force that has been generated by the EPB ECU 9. A flowchart that shows details of the releasing control processing is shown in FIG. 6, and the releasing control processing will be explained with reference to FIG. 6.

First, at Step 300, the target W/C pressure TPWC at the time of release is set. At the time of release, a W/C pressure that is slightly higher than at the time of locking is generated to reduce the load applied to the motor 10. Thus, the target W/C pressure TPWC at the time of release is set at a value that is obtained by adding a constant C to the WIC pressure PLMC when the locking control is completed. Further, in a similar manner to the above described Step 205, the W/C pressure PWC is detected, and it is determined whether or not the W/C pressure PWC exceeds the target W/C pressure TPWC at the time of release. If a no determination is made, the processing advances to Step 305.

At Step 305, in a similar manner to the above described Step 210, it is determined whether or not the ESC is malfunctioning. If the ESC is not malfunctioning, the processing advances to Step 310 where a W/C pressurization instruction is output to the ESC ECU 8, and also a flag is set that indicates that there is presently an instruction to pressurize the W/C. Accordingly, the ESC ECU 8 leaves a pressure-boosting control valve, not shown in the figures, in a connected state, and also sets the differential pressure control valve to a differential pressure state. In addition, the ESC ECU 8 operates the motor and makes the pump perform an intake-discharge operation to pressurize the W/C.

Alternatively, if the ESC is malfunctioning, the processing advances to step 315 and the depression request to the driver is turned on. Then, a signal indicating the depression request to the driver is output to the announcement device 27, and the announcement device 27 uses speech guidance saying “Please depress the brake” etc. to inform the driver. Accordingly, the driver can be induced to depress the brake pedal 3, and a W/C pressure that corresponds to the depression of the brake pedal 3 can be generated.

Thus, even if the actuator 7 is malfunctioning, the driver can be induced to generate the W/C pressure using the service brake 1. In this state, if the braking force of the EPB 2 is released, the piston 19 is urged toward to the left hand side of the figure by the W/C pressure, and thus the load applied to the impelling, shaft 18 is reduced. As a result, the operation of the motor 10 to move the impelling shaft 18 can be performed in an almost unloaded state.

In this manner, even if the actuator 7 is malfunctioning, the W/C pressure can be generated by the service brake 1 by depression of the brake pedal 3 by the driver, thus making it possible to reliably release the braking force generated by the EPB 2. In addition, in the case that no support is provided for the W/C pressure generated by the service brake 1, it is necessary to increase the size of the motor 10 etc. in order to reliably perform release. However, since support can be obtained by the driver depressing the brake pedal 3, there is no need to increase the size of the motor 10 etc. and thus size reduction of the motor 10 can be promoted.

On the other hand, if a yes determination is made at Step 300, a state has been reached in which it is no longer necessary to pressurize the W/C since the W/C pressure generated due to the depression of the brake pedal 3 by the driver or due to the ESC ECU 8 actuating the actuator 7 is sufficient. As a result, the processing advances to Step 320, and it is determined whether or not the ESC ECU 8 is presently being instructed to pressurize the W/C. This determination is made based on whether or not the flag is set that indicates that there is presently an instruction to pressurize the W/C. If it is determined that the flag has been set in the above described Step 310, a yes determination is made, and the flag that indicates that there is presently an instruction to pressurize the W/C is reset. Then, the processing advances to Step 325 where a W/C pressure maintenance instruction is output to the ESC ECU 8. After that, the processing advances to Step 330. As a result, the ESC ECU 8 uses a maintenance function to place the pressure-boosting control valve and the pressure-reducing control valve, not shown in the figures, into a non-connected state, whereby the W/C pressure is maintained. Alternatively, a no determination is made if the flag is not set that indicates that there is presently an instruction to pressurize the W/C, and the processing proceeds as is to Step 330.

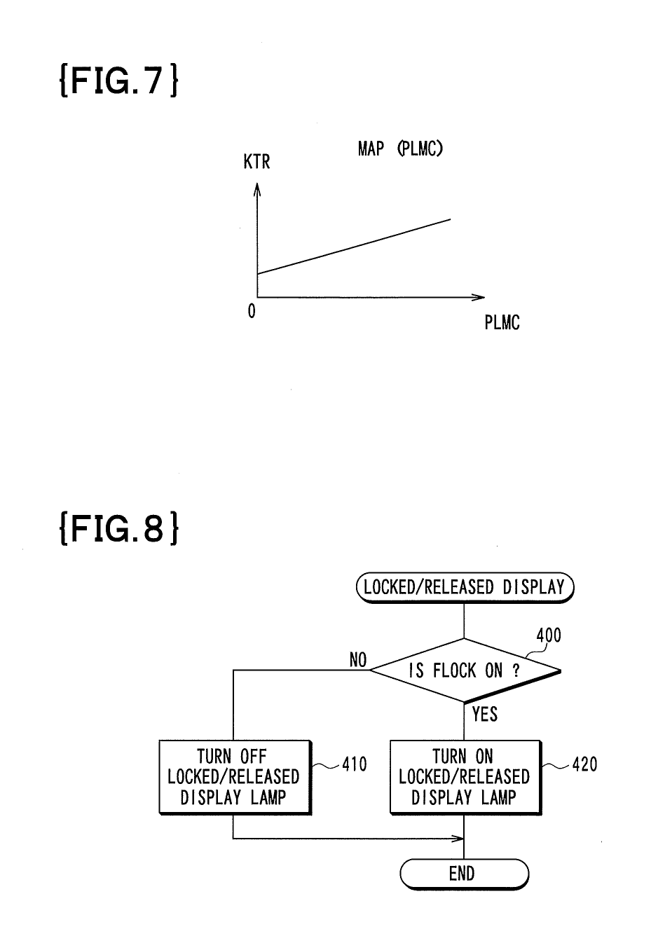

Then, at Step 330, a releasing operation time KTR is set. The releasing operation time KTR is set longer along with increase of a moved amount of the impelling shaft 18 or the piston 19 and the brake pad 11 caused by the motor 10, during locking control. Thus, in the present embodiment, based on a characteristic MAP (PLMC) of the relationship between the release operation time KTR and the W/C pressure PLMC when locking control is completed shown in FIG. 7, the W/C pressure PLMC when locking control is completed is set. More specifically, the higher the W/C pressure applied during locking control is, the more the piston 19 is moved toward the brake pad 11, and therefore time is taken to move the piston 19 back to its initial position. Therefore, setting is performed in advance such that the characteristic MAP (PLMC) becomes larger in line with increase in the W/C pressure PLMC when locking control is completed. Then, this characteristic MAP (PLMC) is set as the release operation time KTR.

Then, the processing advances to Step 335, where a determination is made as to whether or not a releasing control time counter CTR is greater than the releasing operation time KTR that has been set at Step 330. The releasing control time counter CTR is a counter that measures the time that has elapsed since the releasing control was started, and it starts counting at the same time that the releasing control is started.

Therefore, if a state exists in which the releasing control time counter CTR is less than the releasing operation time KTR, the releasing control will still be continued, so the processing advances to Step 340, where the locked state flag FLOCK is set to off, the releasing control time counter CTR is incremented, and a motor releasing operation is turned on, that is, the motor 10 is rotated in the reverse direction. Thus the rotating shaft 17 is rotated in conjunction with the reverse rotation of the motor 10, and the impelling shaft 18 is moved in the direction that separates it from the brake disc 12 by the friction force that is generated by the engaging of the male threaded groove 17a and the female threaded groove 18a. Thus, the piston 19 and the brake pad 11 are also moved in the same direction.

On the other hand, if a yes determination is made at Step 335, the processing advances to Step 345, where the released state flag FREL is set to on, which means that the releasing has been completed, the releasing control time counter CTR is set to zero, and the motor releasing operation is turned off. Therefore, the rotation of the motor 10 is stopped, and the friction force that is generated by the engaging of the male threaded groove 17a and the female threaded groove 18a keeps the brake pad 11 in the state of being separated from the brake disc 12. Next, the processing advances to Step 350, and the depression request to the driver is turned off. Accordingly, output of the signal indicating the depression request to the driver to the announcement device 27 is stopped, and the announcement device 27 stops the speech guidance saying “Please depress the brake” or the like. Then, the processing advances to Step 355 and a W/C pressure release instruction is output to the ESC ECU 8. As a result, the W/C pressure generated by the service brake 1 is released. With this, the releasing control processing is completed.

When the locking control processing and the releasing control processing have been completed as described above, locked/released display processing is performed at Step 150 in FIG. 3. A flowchart that shows details of the locked/released display processing is shown in FIG. 8, and the locked/released display processing will be explained with reference to FIG. 8.

At Step 400, a determination is made as to whether or not the locked state flag FLOCK has been set to on. If a yes determination is made, the processing advances to Step 410, where the locked/released display lamp 26 is turned on, and if a no determination is made, the processing advances to Step 420, where the locked/released display lamp 26 is turned off. Thus, the locked/released display lamp 26 is turned on if the brake mechanism is in the locked state, and the locked/released display lamp 26 is turned off when the brake mechanism is in the released state or the releasing control has been started. This makes it possible to make the driver aware of whether or not the brake mechanism is in the locked state. With that, the locked/released display processing is completed, in conjunction with which the parking brake control processing is completed.

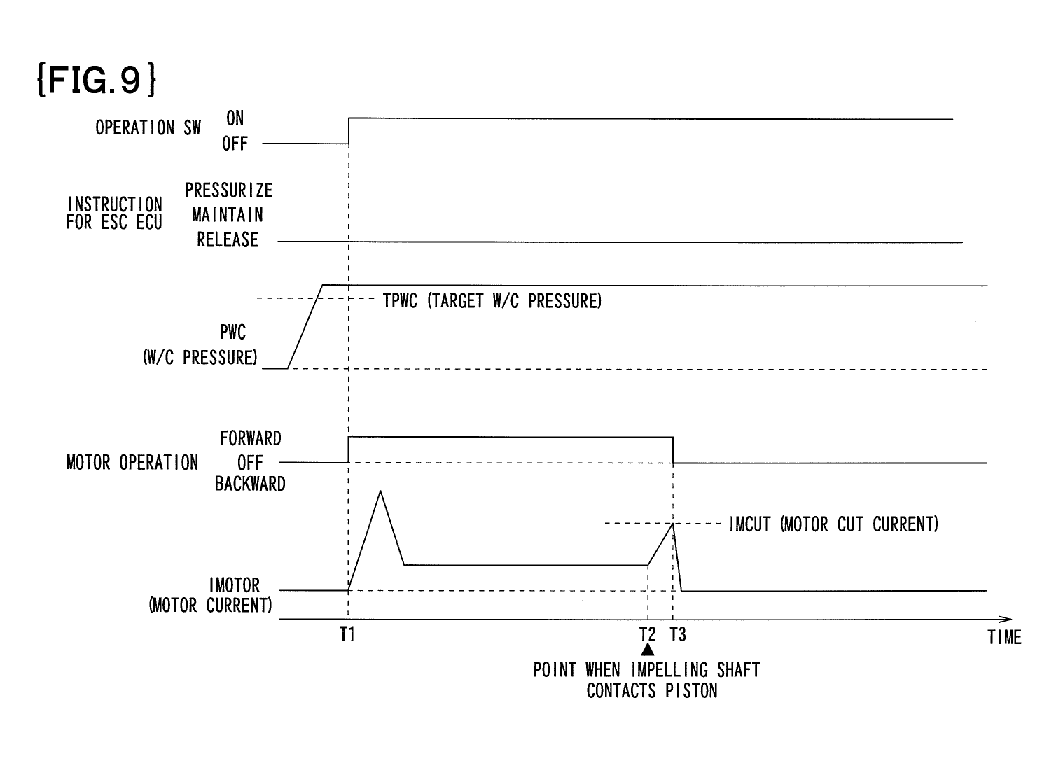

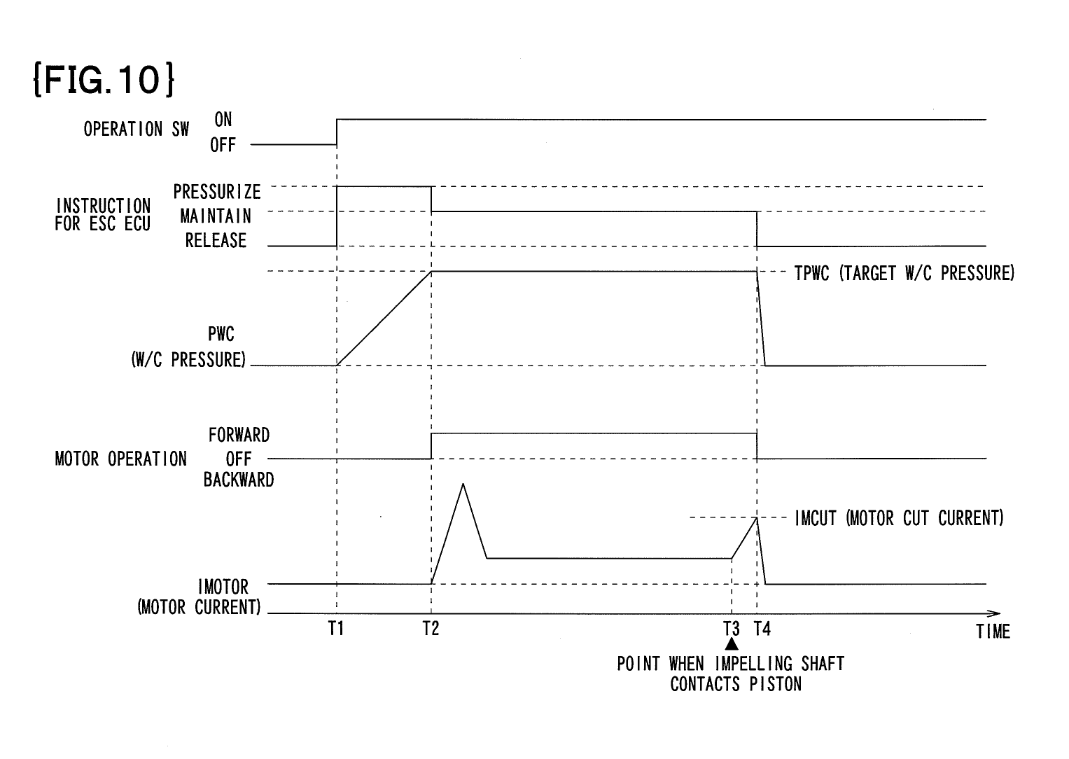

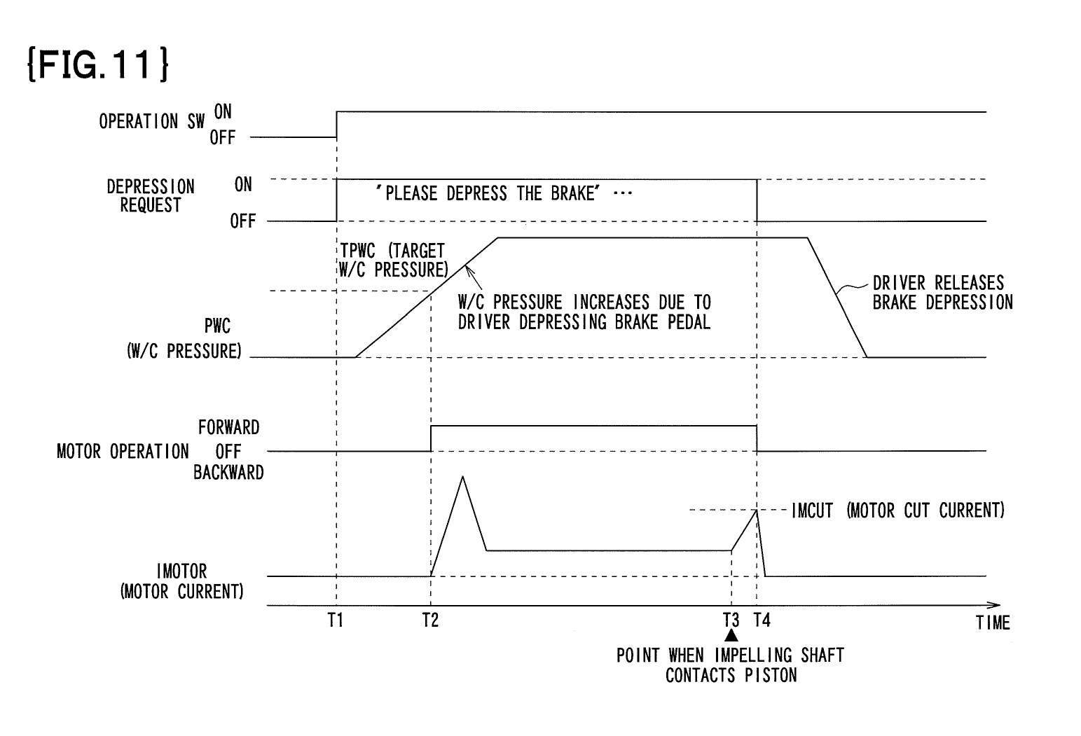

FIG. 9, FIG. 10 and FIG. 11 are timing charts for when the parking brake control processing is performed. More specifically, FIG. 9 is a timing chart for a case when required braking force is generated using just operation of the EPB 2 when locking control is performed or depression of the brake pedal 3 by the driver. FIG. 10 is a timing chart for a case when the ESC is not malfunctioning and required braking force is not generated despite using depression of the brake pedal 3 by the driver when the required braking force cannot be obtained by just operating the EPB 2 when locking control is performed. FIG. 11 is a timing chart for a case where the ESC is malfunctioning and required braking force is not generated despite using depression of the brake pedal 3 of the driver at a time when the required braking force cannot be obtained by just operating the EPB 2 when locking control is performed.

As shown in FIG. 9, in the case when required braking force is generated using just operation of the EPB 2 or depression of the brake pedal 3 by the driver, the W/C pressure generated by either one of these methods becomes larger than the target W/C pressure TPWC. Thus, at time T1, even if the operation SW 23 is turned on, the W/C pressurization instruction is not output to the ESC ECU 8, the motor locking operation of the EPB 2 is turned on, and the impelling shaft 18 is moved toward the brake pad 11 side. At this time, because the piston 19 has already moved toward the brake pad 11 side due to the previously generated W/C pressure, no load is imposed on the motor 10 until the impelling shaft 18 comes into contact with the piston 19, and then the motor current IMOTOR becomes a constant value after a rush current is generated.

After that, when the impelling shaft 18 comes into contact with the piston 19 at time T2, a load is applied to the motor 10, so the motor current IMOTOR increases. When the motor current IMOTOR reaches the target current value IMCUT at time T3, the motor locking operation is stopped. In response to this, the W/C pressure release instruction is output to the ESC ECU 8. After that, the W/C pressure becomes a value that corresponds to the pedal force when the driver depresses the brake pedal 3. Note that FIG. 9 shows a state in which the W/C pressure remains until the depression of the brake pedal 3 is stopped, such as when the W/C pressure is generated by the driver depressing the brake pedal 3.

Next, as shown in FIG. 10, in a case when the ESC is not malfunctioning and required braking force is not generated despite using depression of the brake pedal 3 by the driver when the required braking force cannot be obtained by just operating the EPB 2, at time T1, the operation SW 23 is turned on and at the same time the W/C pressurization instruction is output to the ESC ECU 8. As a result, the differential pressure control valve of the actuator 7, not shown in the figure, is placed into a differential pressure state, and the motor is operated in a state where the pressure-boosting control valve is placed in a connected state. Thus, the W/C pressure is automatically increased due to pump pressure increase.

Next, at time T2, when the W/C pressure reaches the target W/C pressure TPWC, the W/C pressure maintenance instruction is output to the ESC ECU 8. Thus, the motor 10 is turned on, and the impelling shaft 18 is moved toward the brake pad 11 side. The operations following this are the same as those shown in FIG. 9, namely, at time T3, the impelling shaft 18 comes into contact with the piston 19, and then at time T4, when the motor current IMOTOR reaches the target current value IMCUT, the motor locking operation is stopped, and the W/C pressure release instruction is output to the ESC ECU 8.

Furthermore, as shown in FIG. 11, in a case where the ESC is malfunctioning and required braking force is not generated despite using depression of the brake pedal 3 by the driver at a time when the required braking force cannot be obtained by just operating the EPB 2, at time T1, the operation SW 23 is turned on and at the same time a brake depression request is announced to the driver. As a result, the driver depresses the brake pedal 3, which causes the W/C pressure to rise. Then, at time T2, when the W/C pressure reaches the target W/C pressure TPWC, the motor 10 is turned on, and the impelling shaft 18 is moved toward the brake pad 11 side. The operations following this are the same as those shown in FIG. 9, namely, at time T3, the impelling shaft 18 comes into contact with the piston 19, and then at time T4, when the motor current IMOTOR reaches the target current value IMCUT, the motor locking operation is stopped, and the W/C pressure release instruction is output to the ESC ECU 8.

As explained above, in the present embodiment, if the ESC is malfunctioning when the locking control or releasing control of the parking brake is being performed, the depression request for the brake pedal 3 is output to the driver. As a result, when the ESC is malfunctioning, namely, even if the automatic pressurization function of the service brake 1 is malfunctioning, the W/C pressure can be increased by the driver depressing the brake pedal. Thus, it is possible to ensure required braking force at times when the locking control is being performed, and also possible to reliably release when the releasing control is being performed.

### Second Embodiment

A second embodiment of the present invention will now be explained. In the present embodiment, the locking control and the releasing control are modified from those in the first embodiment. However, the present embodiment is otherwise the same as the first embodiment, so only the portions that are different from the first embodiment will be explained.

In the present embodiment, the locking control and the releasing control are performed using a modified method for the brake pedal depression request to the driver depending on a malfunctioning section of the ESC.

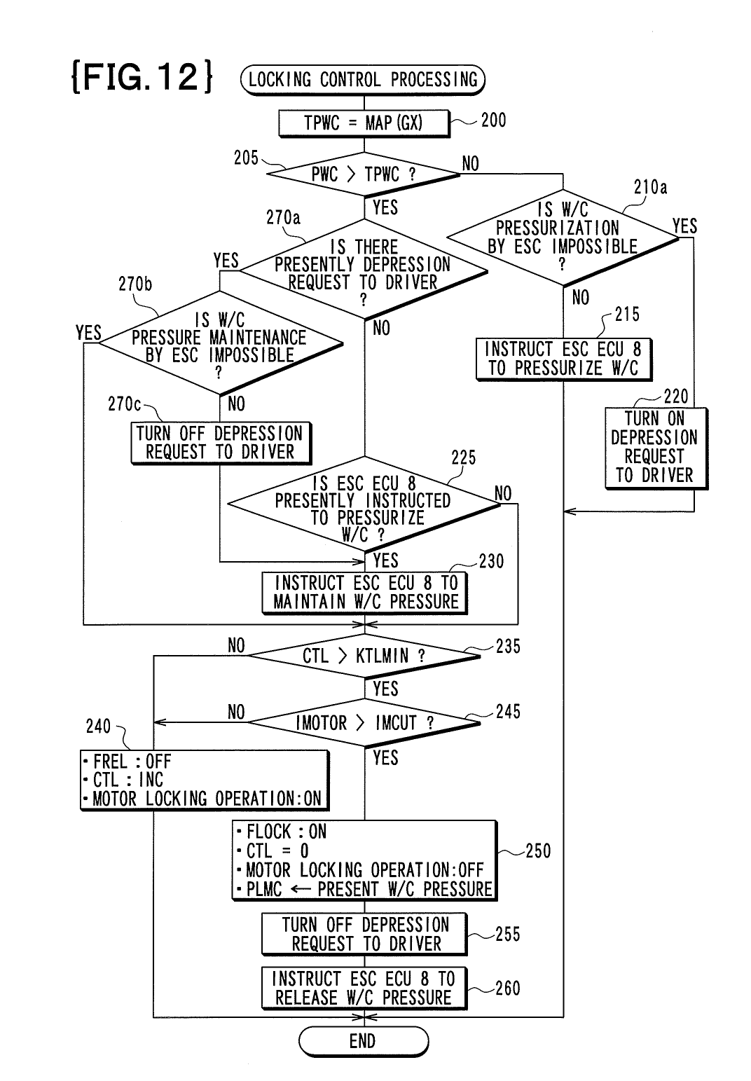

FIG. 12 is a flowchart that shows details of locking control processing according to the present embodiment. As shown in FIG. 12, fundamentally, the processing is the same as the locking control processing shown in FIG. 4 described above. However, at Step 210a, a determination is made as to whether or not W/C pressurization using the automatic pressurization function of the actuator 7 is impossible, instead of determining whether or not the ESC is malfunctioning. More specifically, even if the actuator 7 is malfunctioning, for example, there are times when the malfunctioning section is just the differential pressure valve, and thus even if the automatic pressurization function of the W/C pressure is not performed, the maintenance function is not malfunctioning and the W/C pressure maintenance can be performed. Accordingly, if the driver is induced to depress the brake pedal 3 once to pressurize the W/C, and then that W/C pressure can be maintained, there is no need to induce the driver to continue depressing the brake pedal 3 anymore. Thus, at this point, it is determined whether or not just the automatic pressurization function of the actuator 7 is malfunctioning. Then, based on the determination result at this point, the processing is performed as in the first embodiment at Step 215 and Step 220.

Following this, if a yes determination is made at Step 205, the processing advances to Step 270a, where a determination is made as to whether or not there is presently a depression request to the driver. This determination is made based on whether or not the depression request to the driver was turned on at Step 220. If a no determination is made at this point, the driver is not presently induced to depress the brake pedal 3, and thus the processing advances as is to Step 225. If a yes determination is made, W/C pressure is being generated due to the driver depressing the brake pedal 3, and thus the processing advances to Step 270b.

At step 270b, a determination is made as to whether or not it is impossible to maintain the W/C pressure due to the maintenance function of the actuator 7 malfunctioning. More specifically, if it is not impossible to maintain the W/C pressure, the generated W/C pressure can be maintained and thus no problem will occur even if the driver releases depression of the brake pedal 3. Accordingly, if a no determination is made at this point, the depression request to the driver is turned off at Step 270c, and the processing advances to Step 230 where the W/C pressure maintenance instruction is output to the ESC ECU 8. Alternatively, if it is impossible to maintain the W/C pressure, a yes determination is made and the processing advances to Step 235. In this case, the depression request to the driver is not turned off and thus the driver continues depressing the brake pedal 3 without change. However, since the W/C pressure is generated during the locking control due to the driver depressing the brake pedal 3, the same effect as achieved by the first embodiment can be obtained.

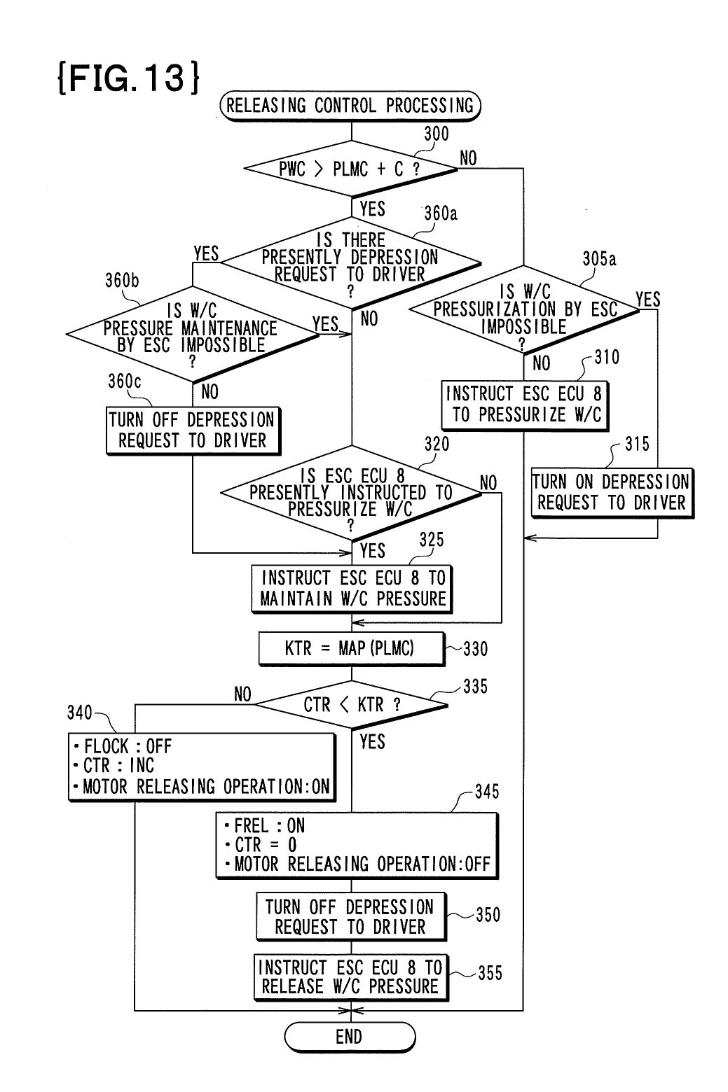

FIG. 13 is a flowchart that shows details of releasing control processing according to the present embodiment. As shown in FIG. 13, fundamentally, the processing is the same as the releasing control processing shown in FIG. 6 described above. However, at Step 305a, a determination is made as to whether or not W/C pressurization using the automatic pressurization function of the actuator 7 is impossible, instead of determining whether or not the ESC is malfunctioning. Even during the releasing control, if the driver is induced to depress the brake pedal 3 once to pressurize the W/C, and then that W/C pressure can be maintained, there is no need to induce the driver to continue depressing the brake pedal 3 anymore. Thus, at this point, it is determined whether or not just the automatic pressurization function of the actuator 7 is malfunctioning. Then, based on the determination result at this point, the processing is performed as in the first embodiment at Step 310 and Step 315.

Following this, if a yes determination is made at Step 300, the processing advances to Step 360a, where a determination is made as to whether or not there is presently a depression request to the driver. This determination is made based on whether or not the depression request to the driver was turned on at Step 315. If a no determination is made at this point, the driver is not presently induced to depress the brake pedal 3, and thus the processing advances as is to Step 320. If a yes determination is made, W/C pressure is being generated due to the driver depressing the brake pedal 3, and thus the processing advances to Step 360b.

At step 360b, a determination is made as to whether or not it is impossible to maintain the W/C pressure due to the maintenance function of the actuator 7 malfunctioning. More specifically, if it is not impossible to maintain the W/C pressure, the generated W/C pressure can be maintained and thus no problem will occur even if the driver releases depression of the brake pedal 3. Accordingly, if a no determination is made at this point, the processing advances to Step 360c, where the depression request to the driver is turned off. Then, the processing advances to Step 325, where the W/C pressure maintenance instruction is output to the ESC ECU 8. Alternatively, if it is impossible to maintain the W/C pressure, a yes determination is made and the processing advances to Step 330. In this case, the depression request to the driver is not turned off and thus the driver continues depressing the brake pedal 3 without change. However, since the W/C pressure is generated during the releasing control due to the driver depressing the brake pedal 3, the same effect as achieved by the first embodiment can be obtained.

In this manner, even if the ESC is malfunctioning, in cases where it is still possible to maintain the W/C pressure depending on the section that is malfunctioning, the driver can be induced to depress the brake pedal 3 once to pressurize the W/C. Following this, the W/C pressure can be maintained so that no problems occur even if the driver does not continue to depress the brake pedal 3 anymore. As a result, it is possible to reduce the extent to which the driver is put to the inconvenience of depressing the brake pedal 3.

### Third Embodiment

A third embodiment of the present invention will now be explained. In the present embodiment, the locking control and the releasing control are modified from those in the first embodiment. However, the present embodiment is otherwise the same as the first embodiment, so only the portions that are different from the first embodiment will be explained.

In the present embodiment, the locking control and the releasing control are performed with a modification to the brake pedal depression request to the driver, which depends on a required depression amount.

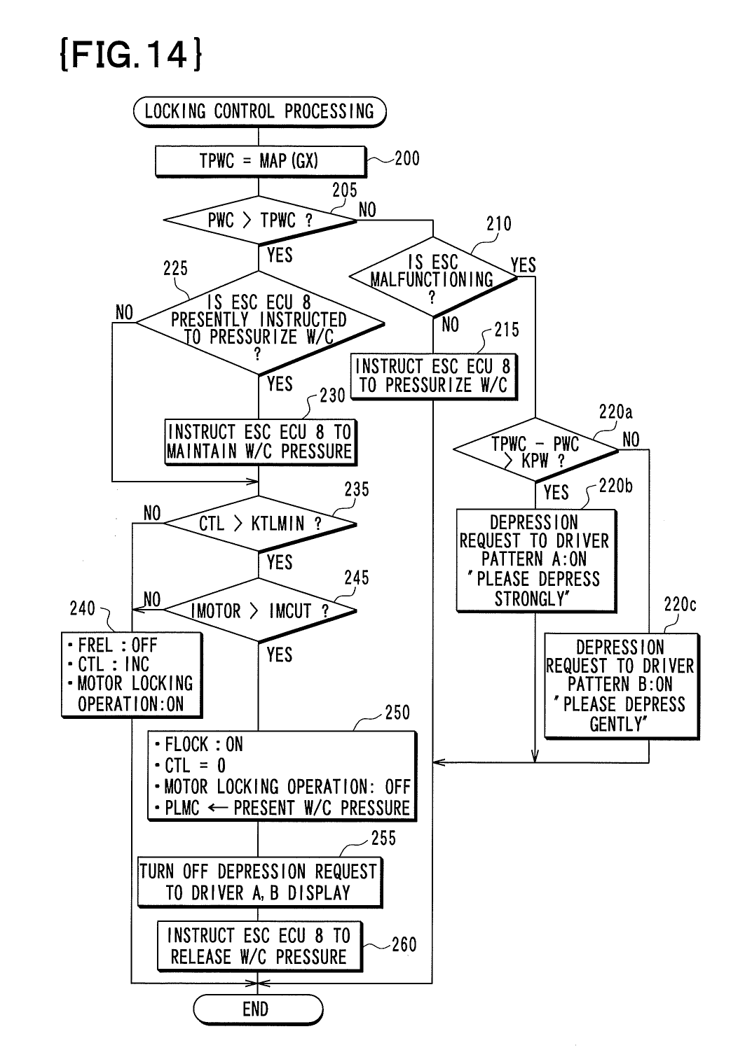

FIG. 14 is a flowchart that shows details of locking control processing according to the present embodiment. In the present embodiment as well, as shown in FIG. 14, fundamentally, the processing is the same as the locking control processing shown in FIG. 4 described above. However, at Steps 220a-220c, the processing that is performed when the ESC is malfunctioning is modified.

More specifically, if a yes determination is made due to the ESC malfunctioning at Step 210, the processing advances to Step 220a, where a determination is made as to whether a value, which is derived by deducting the present W/C pressure PWC from the target W/C pressure TPWC, has exceeded a threshold value KPW. The threshold value KPW is a reference value for use in determining whether a required depression amount is large or small. Then, if the required depression amount is large, and a yes determination is made at Step 220a, the processing advances to Step 220b where the depression request to the driver is turned on, and an announcement is made using a pattern A that has a high warning level. For example, the announcement “Please depress the brake pedal strongly” may be given. Conversely, if the required depression amount is small, a no determination is made at Step 220a, and the processing advances to Step 220c, where the depression request to the driver is turned on, and an announcement is made using a pattern B that has a low warning level. For example, the announcement “Please depress the brake pedal gently” may be given.

In this way, when the depression request to the driver is made during locking control, it is possible to change the warning level given to the driver when depression is requested in accordance with the required depression amount. Accordingly, the driver can be induced to depress the brake pedal 3 more accurately.

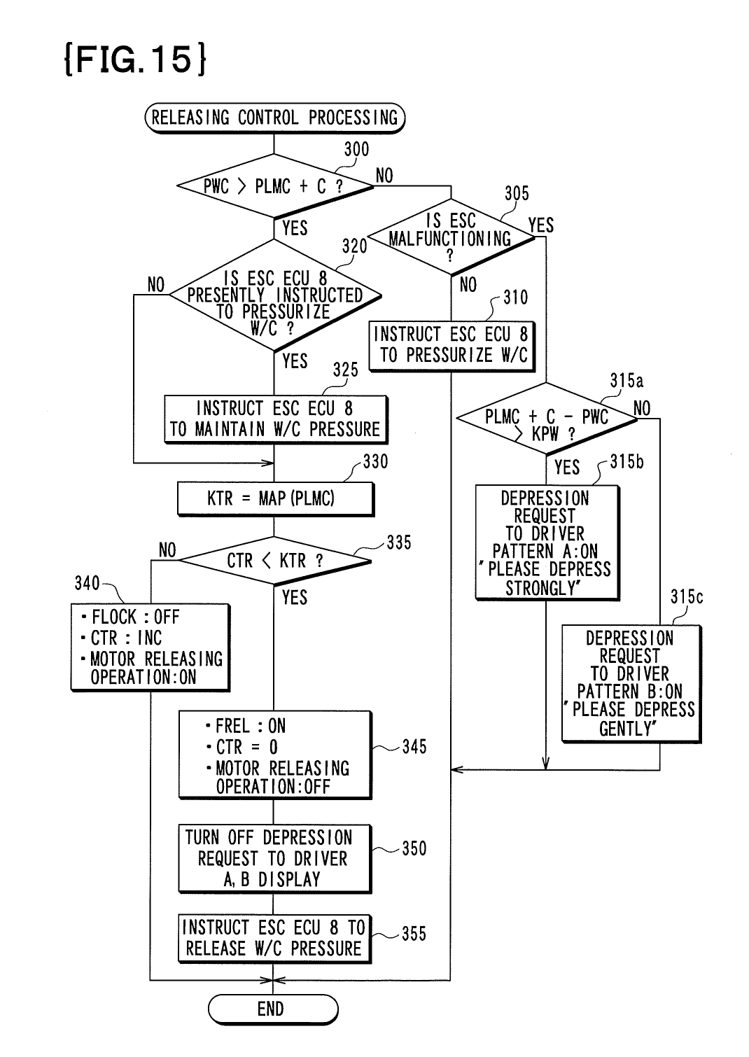

FIG. 15 is a flowchart that shows details of releasing control processing according to the present embodiment. In the releasing control as well, as shown in FIG. 15, fundamentally, the processing is the same as the releasing control processing shown in FIG. 6 described above. However, at Steps 315a-315c, the processing that is performed when the ESC is malfunctioning is modified.

More specifically, if a yes determination is made due to the ESC malfunctioning at Step 305, at Steps 315a-315c, the same processing is performed as at Steps 220a-220c when the locking control is being performed. However, unlike when the locking control is performed, during performance of the releasing control, a value PLMC+C is used as the target W/C pressure TPWC when releasing. The value PLMC+C is obtained by adding the constant C to the W/C pressure PLMC when the locking control is completed.

In this way, in the case of making the depression request to the driver during releasing control as well, it is possible to change the warning level given to the driver when depression is requested in accordance with the required depression amount. Accordingly, the driver can be induced to depress the brake pedal 3 with a more appropriate degree of force.

### Fourth Embodiment

A fourth embodiment of the present invention will now be explained. In the present embodiment as well, the locking control and the releasing control are modified from those in the first embodiment. However, the present embodiment is otherwise the same as the first embodiment, so only the portions that are different from the first embodiment will be explained.

In the present embodiment, the locking control and the releasing control are performed such that they vary in accordance with a state of the depression request for the brake pedal 3 made to the driver.

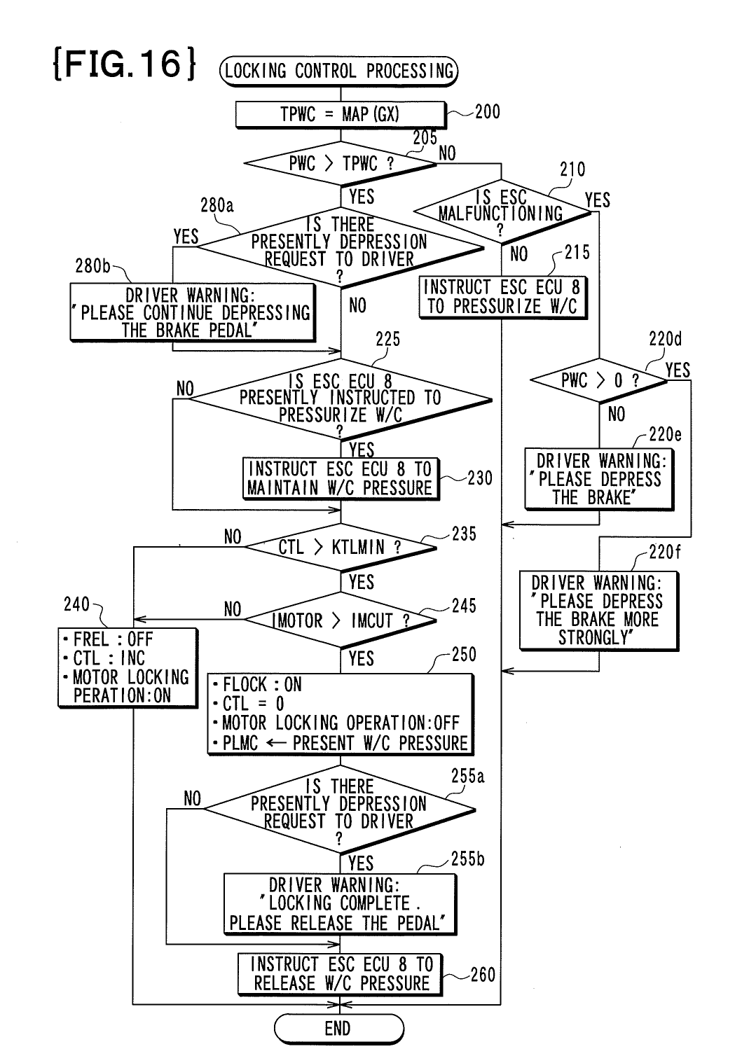

FIG. 16 is a flowchart that shows details of locking control processing according to the present embodiment. In the present embodiment as well, as shown in FIG. 16, fundamentally, the processing is the same as the locking control processing shown in FIG. 4 described above. However, at Steps 220d-220f, the processing that is performed when the ESC is malfunctioning is performed.

First, at Step 220d, a determination is made as to whether or not the generated W/C pressure PWC is greater than zero, namely, whether the W/C pressure PWC is being generated by depression of the brake pedal 3. If a no determination is made at this point, it is presumed that the driver has still not depressed the brake pedal 3, and thus an announcement is made, as the depression request to the driver, saying “Please depress the brake.” Alternatively, if a yes determination is made, it is assumed that the driver is already depressing the brake pedal 3 but to an insufficient extent to make the W/C pressure PWC reach the target W/C pressure TPWC. Thus, an announcement is made, as the depression request to the driver, saying “Please depress the brake more strongly.” In other words, the warning method is modified in accordance with the state of brake depression by the driver, and if the brake pedal 3 has not yet been depressed, the driver is urged to depress it, and if the brake pedal 3 is already being depressed, the driver is urged to depress it more firmly.

Next, if the W/C pressure PWC has reached the target W/C pressure TPWC, a yes determination is made at Step 205, and the processing advances to Step 280a, where a determination is made as to whether there is presently a depression request to the driver as at Step 270a described above. If a yes determination is made at this point, it is necessary for the driver to continue depressing the brake pedal 3, and thus the processing advances to Step 280b where an announcement is made, as the depression request to the driver, saying “Please continue depressing the brake pedal.” As a result, a state is attained in which the W/C pressure generated by the driver depressing the brake pedal 3 is maintained until required braking force is generated by the locking control.

Following this, locking is completed at Step 250, and the processing advances to Step 255a where a determination is made as to whether there is presently another depression request to the driver. If a yes determination is made, the processing advances to Step 255b, where an announcement is made, as the depression request to the driver, saying “Locking is completed. Please release the brake pedal.” Alternatively, when a no determination is made, the driver is not induced to depress the brake pedal 3, and thus the processing advances to perform the processing at Step 260, thereby completing the locking control.

In this way, in the case of making the depression request to the driver during locking control, it is possible to change the warning method used for the driver when depression is requested in accordance with the depression state. Accordingly, the driver can be induced to depress the brake pedal 3 more accurately.

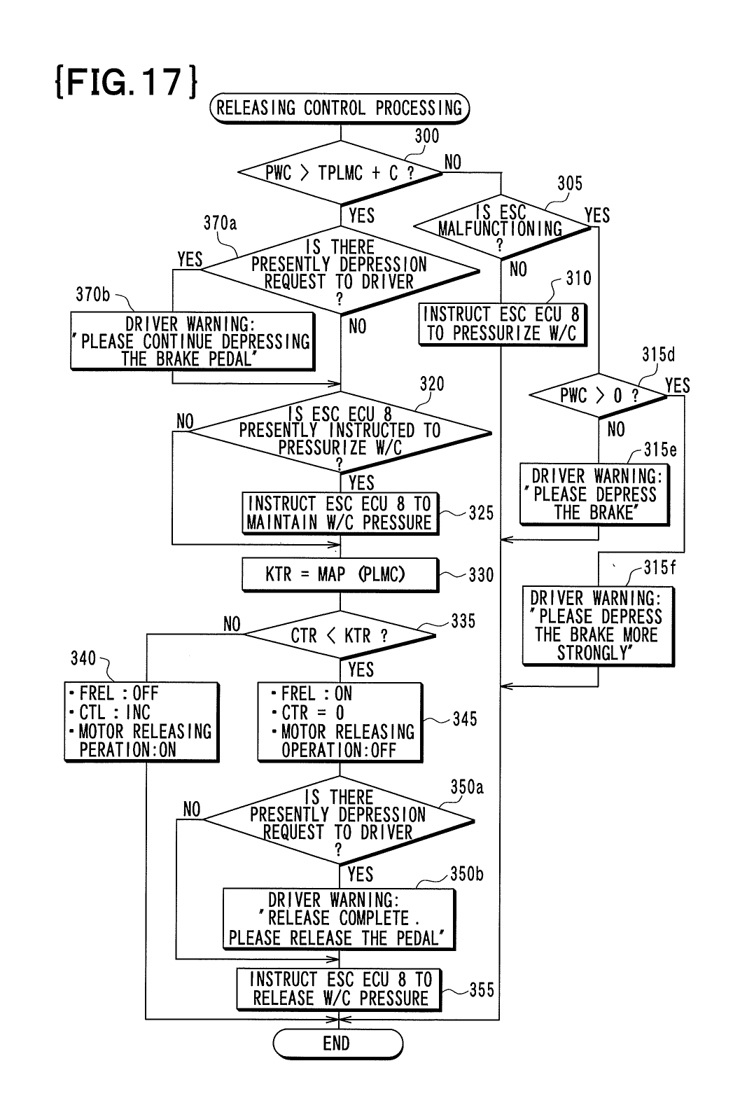

FIG. 17 is a flowchart that shows details of releasing control processing according to the present embodiment. In the releasing control as well, as shown in FIG. 17, fundamentally, the processing is the same as the releasing control processing shown in FIG. 6 described above. However, at Steps 315d-315f, the processing that is performed when the ESC is malfunctioning is modified. More specifically, at Steps 315d-315f, the same processing as at Steps 220d-220f during the locking control is performed.

Further, even if a yes determination is made at Step 205 because the W/C pressure PWC has reached the target W/C pressure TPWC, the same processing as at Step 280a and Step 280b during the locking control is performed at Steps 370a, 370b. Then, when releasing is completed at Step 345, the same processing as at Steps 255a, 255b during the locking control is performed at Steps 350a, 350b.

In this way, in the case of making the depression request to the driver during releasing control as well, it is possible to change the warning method used for the driver when depression is requested in accordance with the depression state. Accordingly, the driver can be induced to depress the brake pedal 3 more accurately.

### Other Embodiments

In the above described embodiments, examples have been explained in which the W/C pressure sensor 25 is used to detect the W/C pressure, but an M/C pressure sensor may also be used instead of the W/C pressure sensor 25, and the W/C pressure may be estimated from the amount that the brake pedal 3 is operated (the pedal force and the stroke). Note that, in the case that a small pedal force is being applied to the brake pedal 3 when the EPB 2 is being operated to perform locking control, a W/C pressure is being generated that is more than the pedal force applied to the brake pedal 3 by the ESC ECU 8. Thus, if a detection signal of the M/C pressure sensor or an operation amount of the brake pedal 3 is used as a basis for estimating the W/C pressure, it is not possible to obtain an accurate W/C pressure. Accordingly, if the W/C pressure is detected based on the M/C pressure sensor or the operation amount of the brake pedal 3, it is preferable to estimate the W/C pressure in accordance with a pressurization time when the W/C pressure is pressurized by the ESC ECU 8.

Furthermore, the different embodiments described above can be combined as appropriate. For example, it is possible to combine elements of the second and third embodiments, namely, as in the second embodiment, in the case that a determination is made concerning malfunctioning of the maintenance function and the maintenance function is not malfunctioning, the W/C pressure maintenance may be performed while cancelling the depression request of the brake pedal 3 for the driver, and, as in the third embodiment, the warning level for the depression request may be varied in accordance with the required depression amount of the brake pedal 3.

Note that the steps that are shown in the various drawings correspond to units that perform the various types of processing. In other words, within the EPB ECU 9, a portion that performs the processing at Steps 200 and 300 is equivalent to a target value setting unit, a portion that performs the processing at Steps 205 and 300 is equivalent to a pressure obtaining unit and a pressure determination unit, a portion that performs the processing at Steps 210 and 305 is equivalent to a pressurization malfunction determination unit, a portion that performs the processing at Steps 220 and 315 is equivalent to a depression request unit, and a portion that performs the processing at Steps 230 and 325 is equivalent to a maintenance unit, a portion that performs the processing at Steps 270a and 360a is equivalent to a maintenance malfunction determination unit, and a portion that performs the processing at Steps 270c and 360c is equivalent to a cancellation unit.

1 . . . SERVICE BRAKE, 2 . . . EPB, 5 . . . M/C, 6 . . . W/C, 7 . . . ESC ACTUATOR, 8 . . . ESC ECU 8, 9 . . . EPB-ECU, 10 . . . MOTOR, 11 . . . BRAKE PAD, BRAKE DISC, 13 . . . CALIPER, 14 . . . BODY, 14a . . . HOLLOW PORTION, 14b . . . PASSAGE, 17 . . . ROTATING SHAFT, 17a . . . MALE THREADED GROOVE, 18 . . . IMPELLING SHAFT, 18a . . . FEMALE THREADED GROOVE, 19 . . . PISTON, 23 . . . OPERATION SW, 24 . . . LONGITUDINAL G SENSOR, 25 . . . W/C PRESSURE SENSOR, 26 . . . LOCKED/RELEASED DISPLAY LAMP, 27 . . . ANNOUNCEMENT DEVICE

1. A parking brake control device including
a first brake means that generates braking force by moving a brake pad toward a brake disk attached to a wheel, the brake pad being moved when an electric motor is operated to rotate,
a second brake means that generates braking force by moving the brake pad toward a brake disk attached to the wheel as a result of a generated wheel cylinder pressure, the wheel cylinder pressure being generated by driver's operation to a brake pedal and an automatic pressurization function, wherein
the parking brake control device is applied to a vehicle such that, during parking, a locking control and a releasing control are performed, the locking control generating braking force on the wheel by operating the first brake means while the wheel cylinder pressure is generated by the automatic pressurization function of the second brake means, and the releasing control releasing the braking force while the wheel cylinder pressure is generated by the automatic pressurization function of the second brake means,
the parking brake control device comprising:
a pressurization malfunction determination means that determines whether the automatic pressurization function of the second brake means is malfunctioning; and
a depression request means that makes a depression request to a driver to request depression of the brake pedal, if the pressurization malfunction determination means determines that the automatic pressurization function is malfunctioning.

2. The parking brake control device according to claim 1, further comprising:
a target value setting means that sets a target value of the wheel cylinder pressure when the locking control or the releasing control is being performed;
a pressure obtaining means that obtains the generated wheel cylinder pressure; and
a pressure determination means that, when the first brake means generates the braking force, determines whether the wheel cylinder pressure generated by the second brake means has exceeded the target value, wherein
if the pressure determination means determines that the wheel cylinder pressure has not exceeded the target value and the pressurization malfunction determination means determines that the automatic pressurization function is malfunctioning, the depression request means makes a depression request to the driver requesting depression of the brake pedal.

3. The parking brake control device according to claim 2, further comprising:
a maintenance malfunction determination means that determines whether a maintenance function of the wheel cylinder pressure performed by the second brake means is malfunctioning;
a maintenance means that maintains the wheel cylinder pressure using the maintenance function of the second brake means; and
a cancellation means that cancels the depression request of the brake pedal, wherein after the depression request means has made the depression request, if the pressure determination means determines that the wheel cylinder pressure has exceeded the target value, the maintenance means maintains the wheel cylinder pressure while the cancellation means cancels the depression request for the brake pedal if the maintenance malfunction determination means determines that the maintenance function is not malfunctioning.

4. The parking brake control device according to claim 3, wherein the depression request means varies a warning level of the depression request given to the driver in accordance with a required depression amount of the brake pedal.

5. The parking brake control device according to claim 4, wherein the depression request means comprises:
a depression amount determination means that determines whether a difference between the target value and the generated wheel cylinder pressure exceeds a threshold value; and
a means that, if the depression amount determination means determines that the difference exceeds the threshold value, makes the warning level of the depression request a higher level as compared to if the difference does not exceed the threshold value.

6. The parking brake control device according to claim 2, wherein the depression request means varies a warning level of the depression request given to the driver in accordance with a required depression amount of the brake pedal.

7. The parking brake control device according to claim 6, wherein the depression request means comprises:
a depression amount determination means that determines whether a difference between the target value and the generated wheel cylinder pressure exceeds a threshold value; and
a means that, if the depression amount determination means determines that the difference exceeds the threshold value, makes the warning level of the depression request a higher level as compared to if the difference does not exceed the threshold value.

8. The parking brake control device according to claim 1, wherein the depression request means varies a warning level of the depression request given to the driver in accordance with a required depression amount of the brake pedal.

9. The parking brake control device according to claim 8, wherein the depression request means comprises:
a depression amount determination means that determines whether a difference between the target value and the generated wheel cylinder pressure exceeds a threshold value; and
a means that, if the depression amount determination means determines that the difference exceeds the threshold value, makes the warning level of the depression request a higher level as compared to if the difference does not exceed the threshold value.

10. The parking brake control device according to claim 1, wherein the depression request means comprises:
a depression determination means that determines whether the brake pedal is being depressed; and
an urging means that, if the depression determination means determines that the brake pedal is not being depressed, urges depression of the brake pedal to be performed, and if it is determined that the brake pedal is being depressed, urges that the brake pedal is depressed further.
